(19) United States
(12) Patent Application Publication
(10) Pub. No.: US 2016/0262358 A1
(43) Pub. Date: Sep. 15, 2016

(54) HUMMINGBIRD BIRD FEEDER

(71) Applicant: Maxine Herrboldt, Ignacio, CO (US)

(72) Inventor: Maxine Herrboldt, Ignacio, CO (US)

(21) Appl. No.: 15/060,969

(22) Filed: Mar. 4, 2016

Related U.S. Application Data
(60) Provisional application No. 62/130,028, filed on Mar. 9, 2015.

(51) Int. Cl. A01K 39/02

(52) U.S. Cl. CPC A01K 39/0206

(57) ABSTRACT

A bird feeder for distributing bird feed that includes: a top portion, where the top portion includes a top feed chamber; a bottom portion, where the bottom portion includes a bottom feed chamber and the top portion removably engages with the bottom portion to form the bird feeder; a base, where the base attaches to the bottom portion to enable the flow of bird feed from the bottom feed chamber to the base; and a plurality of feeders around the perimeter of the base. The top feed chamber and bottom feed chamber are adapted to store simulated nectar. The bird feeder also includes an opening at the bottom of the bottom feed chamber, where the opening is adapted to release bird feed through a stem, where the stem attaches to a base by connecting to a base attachment. Further, the base includes a plurality of conduits extending from the base attachment, where each conduit includes a feeder.

### CROSS REFERENCE TO OTHER APPLICATIONS

This application claims priority to U.S. Provisional Application Ser. No. 62/130,028 filed on Mar. 9, 2015.

### BACKGROUND OF THE INVENTION

1. Field of Invention

The present invention relates to a birdfeeder specifically designed to attract hummingbirds.

2. Description of Related Art

Hummingbird feeders are used by many bird lovers to attract hummingbirds. The typical hummingbird feeder providers simulated nectar usually in the form of water sweetened with sugar or honey. A container or reservoir is used to hold the liquid substance that is allowed to flow into the feeders provided along the parameter of the hummingbird feeder. One common problem with hummingbird feeds is that the sugar water is viscus by nature and therefore can become clogged and require a substantial amount of maintenance in order to have a functioning birdfeeder. As a consequence, the owner or user of a hummingbird feeder needs to regularly clean and maintain the birdfeeder to ensure that the feed is flowing through the birdfeeder and is available for the hummingbirds. It would therefore be advantageous to have a device that is easily assembled and disassembled to ensure proper cleaning of the hummingbird feeder and for the easy flow of feed through the feeder.

### SUMMARY OF THE INVENTION

The present invention relates to a bird feeder for distributing bird feed that includes: a top portion, where the top portion includes a top feed chamber; a bottom portion, where the bottom portion includes a bottom feed chamber and the top portion removably engages with the bottom portion to form the bird feeder; a base, where the base attaches to the bottom portion to enable the flow of bird feed from the bottom feed chamber to the base; and a plurality of feeders around the perimeter of the base. The top feed chamber and bottom feed chamber are adapted to store simulated nectar. The bird feeder also includes an opening at the bottom of the bottom feed chamber, where the opening is adapted to release bird feed through a stem, where the stem attaches to a base by connecting to a base attachment. Further, the base includes a plurality of conduits extending from the base attachment, where each conduit includes a feeder.

### BRIEF DESCRIPTION OF DRAWINGS

FIG. 1 depicts a hummingbird feeder in according with the present invention.

### DETAILED DESCRIPTION

The present invention relates to a hummingbird feeder that is collapsible into two hemispheres. The hummingbird feeder according to present invention is a substantially egg-shaped feeder that includes a feed chamber enclosed into the interior of the feeder. The feeder is disassembled through twisting of the top portion apart from the bottom portion, allowing access to the feed chamber within the interior of the feeder. This feeder in-turn attaches to a base that distributes the feed to individual feeders along the parameter of the base. Conduits are provided that allow for the flow of the bird feed into the prospective feeders along the parameter of the base.

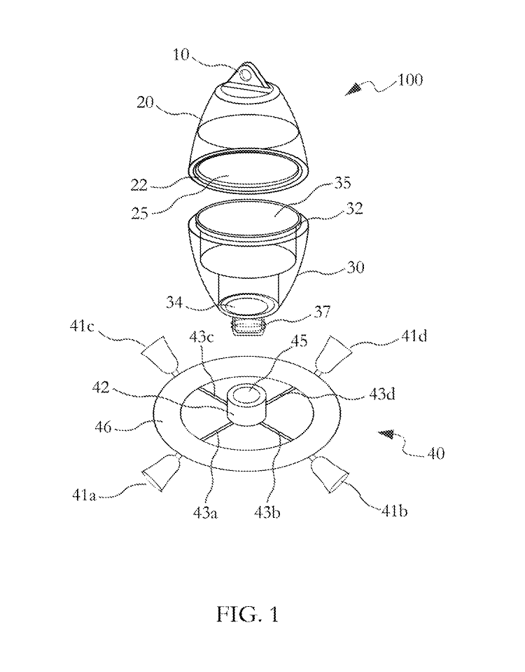

With respect to FIG. 1, a bird feeder 100 is depicted. The birdfeeder 100 includes a top portion 20 and a bottom portion 30 that are joined together through the use of threading provided on each portion of the birdfeeder. A top feed chamber 25 joins with a bottom feed chamber 35 then the two portions of the feeder are joined together. Threads 22 are provided on the inside of the top feed chamber 25 and adjoining male threads 32 are provided extending from the bottom feed chamber 35. A user twists these threads together to join the top portion 20 to the bottom portion 30.

Once joined the feed chambers 25, 35 unite and create a chamber for the storage of the simulated nectar used to feed and attract hummingbirds. An opening 34 is provided at the bottom of the bottom feed chamber 35 that releases bird feed through a stem 37. The stem 37 attaches to a base 46 by connecting to a base attachment 42. The base attachment 42 includes threading to allow for the attachment of the assembled birdfeeder 100. Once attached the flow of nectar goes through a feed open 34 and is distributed through a series of conduits 43(a), 43(b), 43(c) and 43(d). These conduits lead to feeders along the parameter of the base 46. Feeders 41(a), 41(b), 41(c), 41(d) include openings that allow the birds to access the nectar that is being distributed through the birdfeeder 100. A hook attachment 10 is provided at the top of the top portion 20 that includes an opening to allow for the hanging of the birdfeeder in an appropriate position. This keeps the birdfeeder in a vertical positon to allow for the flow of nectar through opening 34 and further into the base 46. The convenience of the birdfeeder 100 relates to the ability to easily disassemble the birdfeeder 100 and therefore allow for easy cleaning of both the feed chambers 25, 35 and the feed opening 34. Further the base 46 can be readily cleaned when disattached from the bottom portion 30. The instant invention has been shown and described in what it considers to be the most practical and preferred embodiments. It is recognized, however, that departures may be made there from within the scope of the invention and that obvious modifications will occur to a person skilled in the art.

What is claimed is:

1. A bird feeder for distributing bird feed comprising:
a. a top portion, where the top portion includes a top feed chamber;
b. a bottom portion, where the bottom portion includes a bottom feed chamber and the top portion removably engages with the bottom portion to form the bird feeder;
c. a base, where the base attaches to the bottom portion to enable the flow of bird feed from the bottom feed chamber to the base; and
d. a plurality of feeders around the perimeter of the base.

2. The bird feeder according to claim 1, where in the top feed chamber and bottom feed chamber are adapted to store simulated nectar.

3. The bird feeder according to claim 1, further including an opening at the bottom of the bottom feed chamber, where the opening is adapted to release bird feed through a stem.

4. The bird feeder according to claim 3, where the stem attaches to a base by connecting to a base attachment.

5. The bird feeder according to claim 3, where the base includes a plurality of conduits extending from the base attachment.

6. The bird feeder according to claim 5, where each conduit includes a feeder.

7. The bird feeder according to claim 1, further including a hook attachment at the top of the top portion adapted to enable vertical suspension of the bird feeder.
